(19) United States
(12) Patent Application Publication
(10) Pub. No.: US 2015/0242389 A1
(43) Pub. Date: Aug. 27, 2015

(54) TECHNIQUES TO IDENTIFY USER INTERFACE ELEMENTS ASSOCIATED WITH MODEL VIOLATION EVENTS

(71) Applicant: NETAPP, INC., Sunnyvale, CA (US)

(72) Inventor: Christopher Morrissey, Apex, NC (US)

(73) Assignee: NETAPP, INC., Sunnyvale, CA (US)

(21) Appl. No.: 14/529,921

(22) Filed: Oct. 31, 2014

Related U.S. Application Data
(60) Provisional application No. 61/945,712, filed on Feb. 27, 2014.

(51) Int. Cl. G06F 17/27; G06F 3/0484; G06F 17/22

(52) U.S. Cl. CPC G06F 17/2725; G06F 17/2247; G06F 3/0484

(57) ABSTRACT

Techniques to identify user interface elements associated with model violation events. These techniques may involve a user interface component configured to perform client-side validation of data objects that are generated by an application running on a client device. This application may communicate with another application operative on a server and the client device. The application may generate a user interface to facilitate user inputs into user interface elements. The server may provide the client device with validation logic that is operative to process any input data directed towards the application via the user interface and identify any violation event of a model shared between the server and the client device.

### RELATED APPLICATION

This application claims the benefit of priority under 35 U.S.C. §119(e) to U.S. Provisional Patent Application 61/945,712 titled “Techniques To Identify User Interface Elements Associated With Model Violations” filed on Feb. 27, 2014, the entirety of which is hereby incorporated by reference.

### BACKGROUND

User interfaces generally allow users to enter data for processing by computer applications. For example, web portal-based user interfaces are typically implemented for web applications, such as those running on a web server over a network. A typical web application's architecture involves partitioning the user interface into three or more components of which each may implement a separate validation system involved in validating the user entered data. Most if not all validations performed in each of these levels are the same across all levels. This and other redundancies place considerable limitations on application development (e.g., testing) and user experience. For example, inefficient validation restricts code base size, especially client-side code, and often results in bottlenecks and excessive load time. Furthermore, having multiple validations on the same data almost always causes issues throughout the maintenance process as new validations are added but not replicated properly. Sometimes, different implementations at separate levels conflict. Occasionally, there is no implementation at all in a particular level even when the validation should be implemented at that particular level.

### BRIEF DESCRIPTION OF THE DRAWINGS

FIGS. 1A-B illustrate an embodiment of a system to identify user elements associated with violation events.

FIG. 2 illustrates an embodiment of a distributed system for the system of FIG. 1.

FIG. 3 illustrates an embodiment of a web client for the system of FIG. 1.

FIG. 4 illustrates an embodiment of a validation process between components of the system of FIG. 1.

FIG. 5 illustrates an embodiment of a logic flow for the system of FIG. 1.

FIG. 6 illustrates an embodiment of a logic flow for the system of FIG. 1.

FIG. 7 illustrates an embodiment of a logic flow for the system of FIG. 1.

FIG. 8 illustrates an embodiment of a web portal for the system of FIG. 1.

FIG. 9 illustrates an embodiment of computing architecture.

FIG. 10 illustrates an embodiment of communications architecture.

### DETAILED DESCRIPTION

Various embodiments are generally directed to client-side validation for a distributed application. Some embodiments are particularly directed to techniques to enable an application's user interface to perform the client-side validation, devolving such validation from a server. Instead of bootstrapping constraints onto the application's classes by modifying/adding metadata, one or more embodiments incorporate custom validation logic into the application's user interface framework. Other embodiments are described and claimed.

In one or more embodiments, the server provides (e.g., shares) code to validate input data corresponding to the user interface and identify user interface elements associated with violation events. The validation logic may create a violation event when a model value is found to violate the allowed state. Hence, the server may be known as a validation provider that communicates validation logic to run on a client device and perform object validation without bootstrapping an existing validation process. These user interface elements may correspond to user entered data in violation of model properties. Some embodiments implement a user interface architecture that allows validation of the user entered data and violation handling within a same code base. As a result, the embodiments can improve affordability, scalability, modularity, extendibility, or interoperability for an operator, device or network.

Some embodiments of the user interface architecture are based upon a model-view-presenter design pattern where a view component supported by a model component is created although neither have a knowledge of the other. A presenter component loads data from the model component into the view component and vice versa. Hence, the view component may be completely detached from validation. Some embodiments described herein adapt a user interface implementing the view-presenter design pattern with a user interface component operative to untie validation from the model component. The user interface component may extend the presenter component or may be a separate component in a new design pattern.

As described herein, the user interface component executes validation logic to perform object validation based upon the model and return any violation events. The violation event may include a name of the model property that caused the violation. In response, the user interface component may display a violation notification to a user. The view component, while having no direct knowledge of the model instance, maintains a mapping associating the model property with a user interface element corresponding to the violation, allowing for efficient unit testing in some embodiments.

In one embodiment, the user interface component may implement an ability to share the validation logic across both the server and a client device. In one embodiment, the user interface component may also implement a well-defined standard (e.g., Java® Bean Validation Specification) for handling validations on the server and the client device in a single code base. Furthermore, the violation event is tied to the user interface elements using a separate data object that associates the user interface element with the model property. Hence, user input may be validated using the validation logic as the user types in a generic way. The validation logic can be run on the server to ensure the user entered data passed from the client device or a programmatic API conforms to the model's properties.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

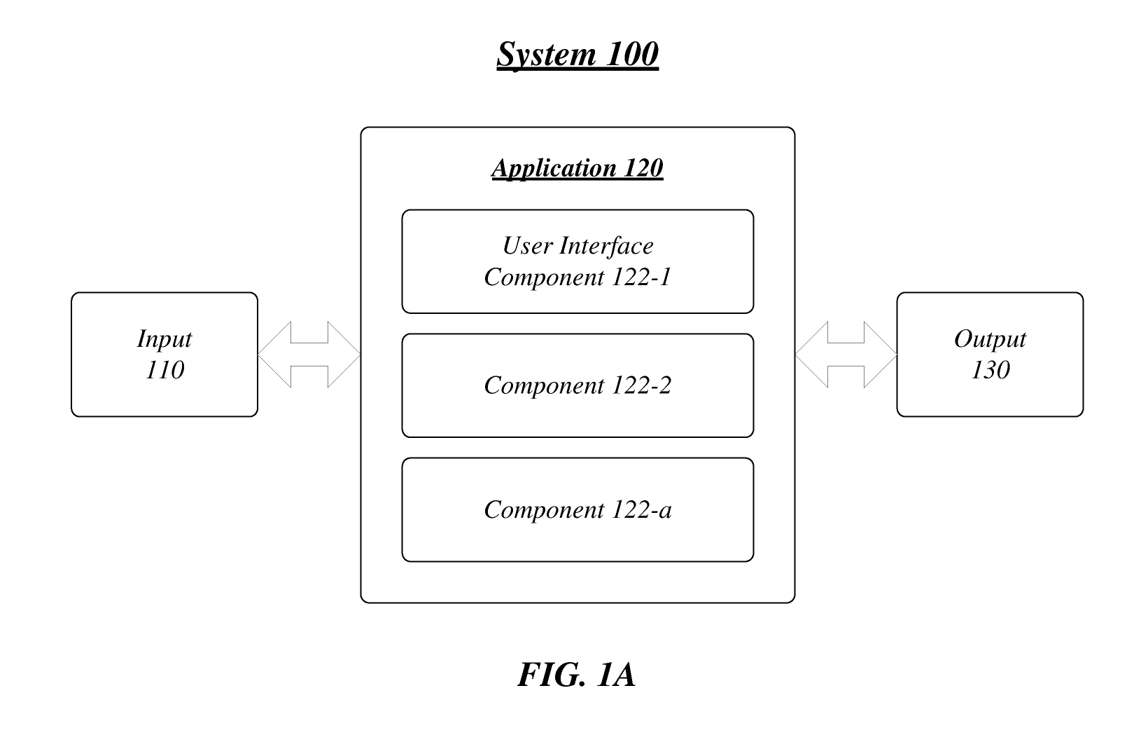

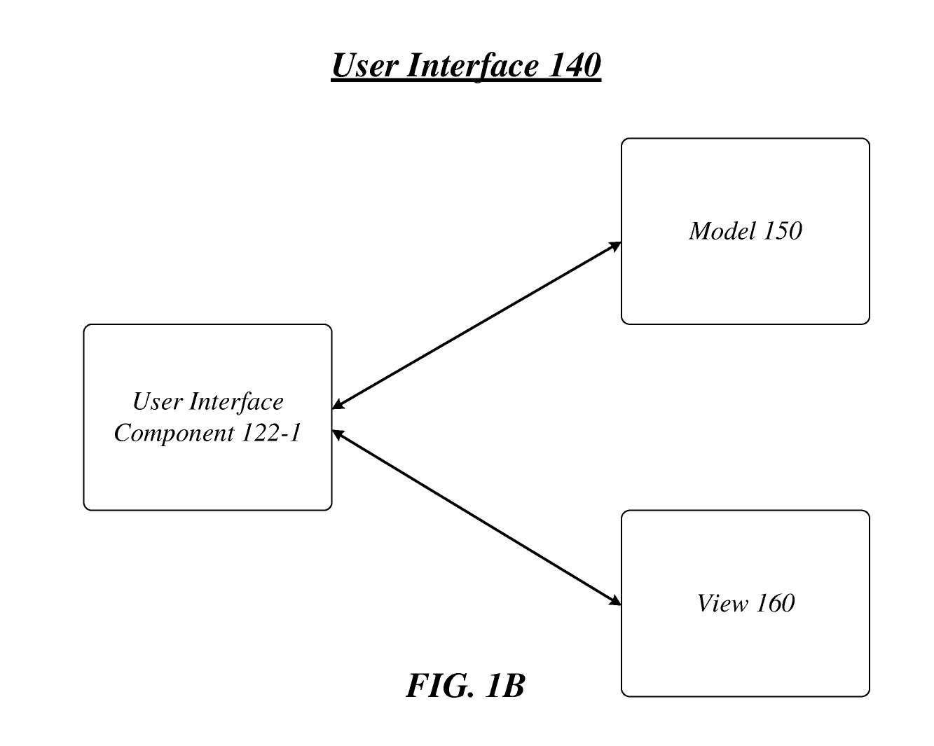

FIG. 1 illustrates a block diagram for a system 100. In one embodiment, the system 100 may comprise a computer-implemented system 100 having a software application 120 comprising one or more components 122-a. Although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The system 100 may comprise the application 120. The application 120 may be generally arranged to facilitate user interaction over a network with various computing resources. It is appreciated that the application 120 may include any number of hardware/software components that perform some functionality. As an example, the application 120 may be an Internet or web application operative on an operating system component, such as a browser component. As another example, the application 120 may be a virtualization manager application configured to control other virtualization components distributed throughout a computing enterprise.

The application 120 may comprise a user interface component 122-1. The component 122-1 may be generally arranged to facilitate user interaction with the capabilities provided by the application 120. As described herein, the user interface component 122-1 may enhance validation and/or violation handling at the application 120 by recording user interface element and model property associations. When a violation event is discovered, the user interface component 122-1 may map the violating model property with a corresponding user interface element in order to identify which user input caused the violation.

FIG. 1B is a functional block diagram of a user interface 140 in the system 100. The user interface component 122-1 loads data and/or code from or into a model 150, performs various operations on such data and/or code, and presents the user interface 140 as a view 160. The model 150 generally defines the view 160 and comprises various properties that conform application data in some manner. The model 150 includes constraints on various data objects being instantiated by the application 120. As described herein, when a data item in a data object violates the model 150, the user interface component 122-1 may use the view 160 to map such violation to a user interface element through which the violation occurred.

Although other embodiments implement other application architectures, FIG. 1B depicts a model-view-presenter design pattern where at least a portion of the user interface component 122-1 operates at least part of the presenter for the application 120. Hence, the application 120 may represent a client application that receives content form a server running a server application. Combined, the application 120 and the server application comprise portions of a distributed application. In an embodiment, the server communicates at least some of the application 120 to run on the client device.

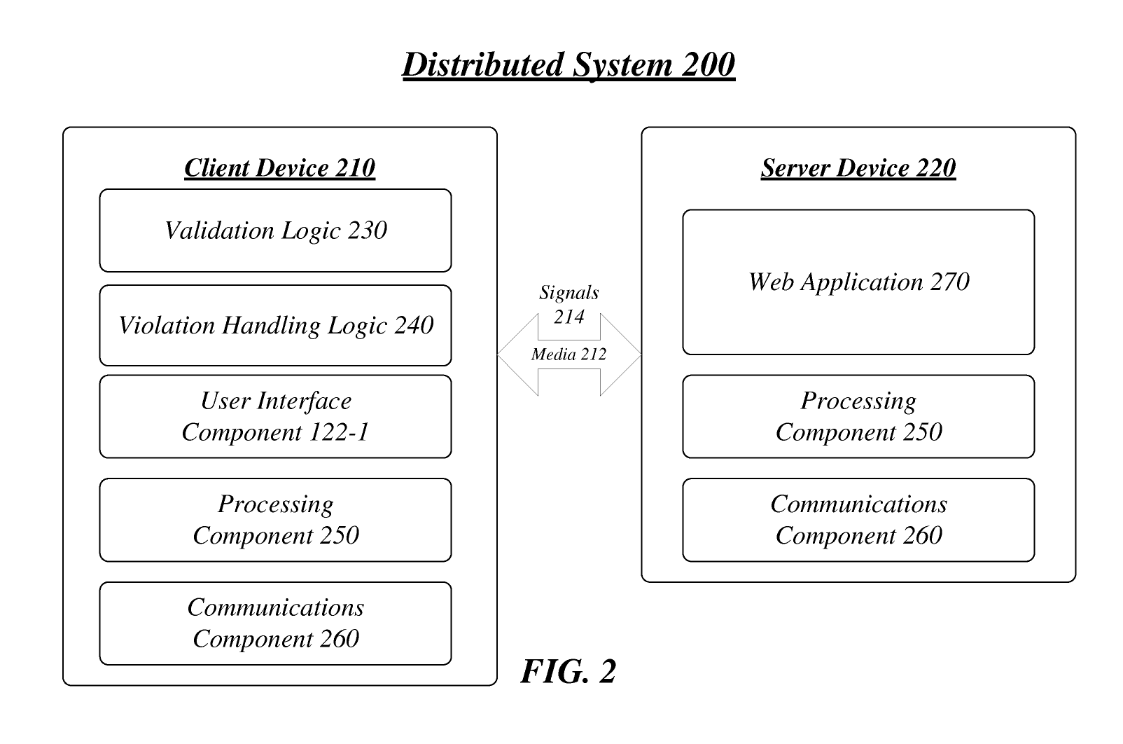

FIG. 2 illustrates a block diagram of a distributed system 200. The distributed system 200 may distribute portions of the structure and/or operations for the system 100 across multiple computing entities. Examples of distributed system 200 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

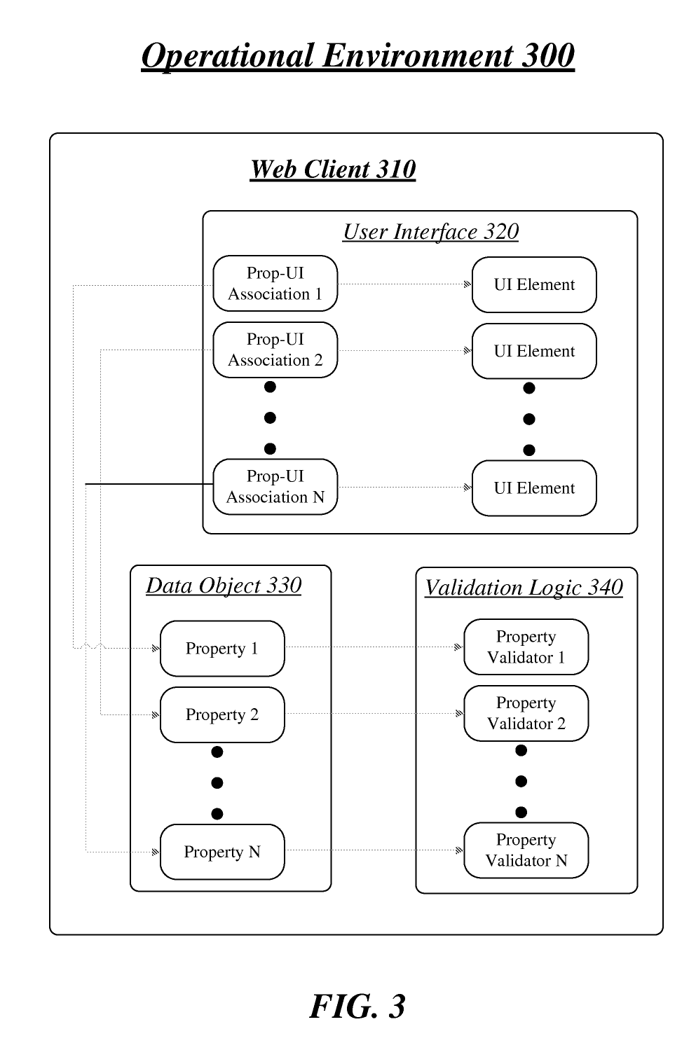

The distributed system 200 may comprise a client device 210 and a server device 220. In general, the client device 210 and the server device 220 may be the same or similar to the web client 310 as described with reference to FIG. 3. For instance, the client device 210 and the server device 220 may each comprise a processing component 250 and a communications component 260. In another example, the devices 210, 220 may communicate over a communications media 212 using communications signals 214 via the communications components 260.

The client device 210 may comprise or employ one or more client programs that operate to perform various methodologies in accordance with the described embodiments. In one embodiment, for example, the client device 210 implements validation logic 230 comprising instructions configured to perform object validation on data objects storing input data items. The user interface component 122-1 generates the data objects as a model instance in which each input data item maps to a model property. To determine whether or not an input data item complies the model property, the user interface component 122-1 executes the validation logic 230 as the input data items are submitted to the client device 210. Instead of extending the data object's metadata with model constraints (e.g., as annotations), the validation logic 230 enables validation of the input data items without modifying any classes for the model instance.

According to one embodiment, the client device 210 implements violation handling logic 240 configured on the user interface to map violation events to user interface elements. The violation handling logic 240 may record mappings in an object, which may be referred to as a validation object. This object may correspond directly with the data object storing the input data, as illustrated in FIG. 3. In one embodiment, the user interface component 122-1 communicates the violation events to the validation object and the violation handling logic 240, which in turn generates violation notifications to present on the user interface, forcing a repopulation of at least one input data item into the model instance and a validation of that model instance.

The server device 250 may comprise or employ one or more server programs that operate to perform various methodologies in accordance with the described embodiments. In one embodiment, for example, the server device 250 implements a web application 270 that is operative to provide rich Internet content to the client device 210. The web application 270 may share code for the validation logic 230 with the user interface component 122-1 through various mechanisms, coalescing the validation logic 230 with the user interface component 122-1 into at least part of a single code base. The rich Internet content includes code and/or data operative to produce the user interface for presentation to a user of the client device.

FIG. 3 illustrates an embodiment of an operational environment 300 for the system 100. As shown in FIG. 3, the operational environment 300 includes a web client 310, which may be an embodiment of the application 120 of FIG. 1 or the client device 210 of FIG. 2. The web client 310 includes a user interface 320, a data object 330 and validation logic 340. The data object 330 may represent a structure organized in computer memory to store data items for a model instance. Accordingly, the data object 330 is examined for any data items violating the model instance.

Components of the user interface 320 may maintain information comprising mappings between model properties of the data object 330 and user interface elements. Such mappings may be depicted in FIG. 3 as “Prop-UI Association 1,” “Prop-UI Association 3,” and “Prop-UI Association N” and may be stored as a separate object. The data object 330 in the web client 310 may store information regarding the model properties. As mentioned herein, a model-view-presenter design pattern separates an application's architecture into a model defining model properties for application data and a view displaying the user interface 320 on a computing device. Instead of isolating validation tasks, the validation logic 340 enables validation of the data object 330 for a (user interface) component that is configured to access the application data and the model properties. A presenter operates as an example component that in general loads data related to the model and transforms that data into an appropriate format for communication to the view.

The validation logic 340 may generally refers to Java code configured to identify violation events based upon rules/constraints specified by the model properties. Components of the validation logic 340 may include property validators that each correspond to a model property in the data object 330. In response to a violation, the validation logic 340 generates a mapping between the model property and a corresponding user interface element. The mapping includes information describing the violation event and identifying a data item in the data object 330 in violation of the model properties. In an embodiment, the data item refers to stored input data from a user.

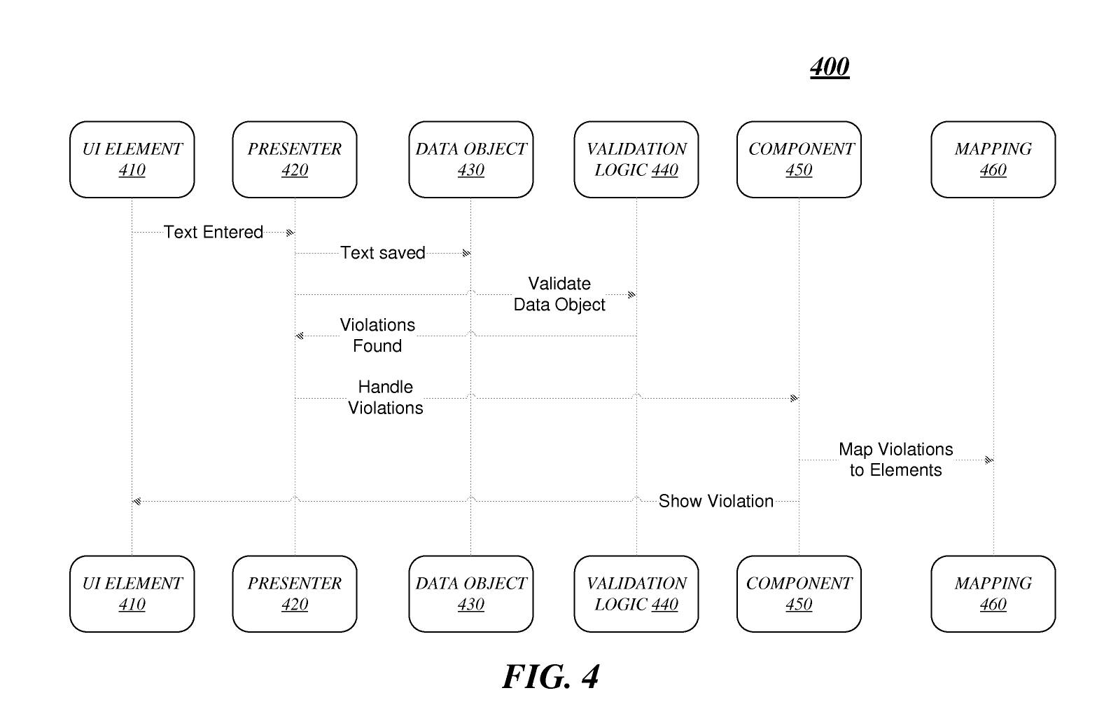

FIG. 4 illustrates a block diagram depicting an interaction sequence 400 between components of the system 100 of FIG. 1.

As shown in FIG. 4, the interaction sequence 400 commences when user entered text is processed as input by a user interface (UI) element 410 and a presenter 420 stores the text and a corresponding model property in a data object 430. It is appreciated that other forms of input data may be processed including, without limitation, image data, audio/video data, application data (e.g., spreadsheets, documents, etc.) and any other data acceptable by the UI element 410. Validation logic 440 accesses the data object and attempts to determine whether the user entered text is in violation of a model. If the validation logic 440 identifies a model violation, a list of violation events is communicated to the presenter 420, which invokes a component 450 configured to handle the violation events. The component 450 may include code that conforms to an application programming standard for client-side handling of violation events. The component 450 may map each violation event to the user interface element into which the user entered data was received as input. The component 450 also may alert the user to each violation event by presenting indicators to the violating user interface element.

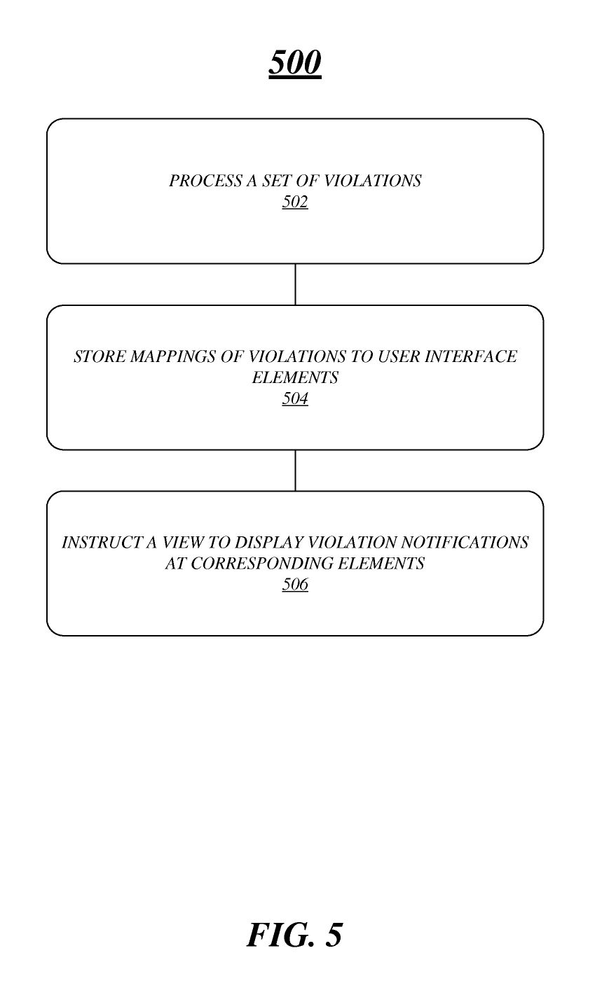

FIG. 5 illustrates one embodiment of a logic flow 500. The logic flow 500 may be representative of some or all of the operations executed by one or more embodiments described herein.

In the illustrated embodiment shown in FIG. 5, the logic flow 500 processes a set of violation events at block 502. These violation events comprise model violations that are identified on a client-side of an application's user interface design as described herein. In an embodiment, a user interface component running on a client device may execute validation logic and generates a list of violation events caused by user-entered data. It is appreciated that in other embodiments, the user interface component may identify other types of model violations including those violation events having causes other than incorrect user-entered data, such as a violation caused by logic errors in the application.

The logic flow 500 may store mappings of violation events to corresponding user interface elements at block 504. The user interface component may generate a separate object and store the mappings in this object. Using these mappings, the user interface component may identify a user interface element associated with a particular violation.

The logic flow 500 may instruct a view to display the violation events at corresponding elements at block 506. For example, the view may present visual indicia around the user interface element comprising user entered text that resulted in the violation. The embodiments are not limited to this example.

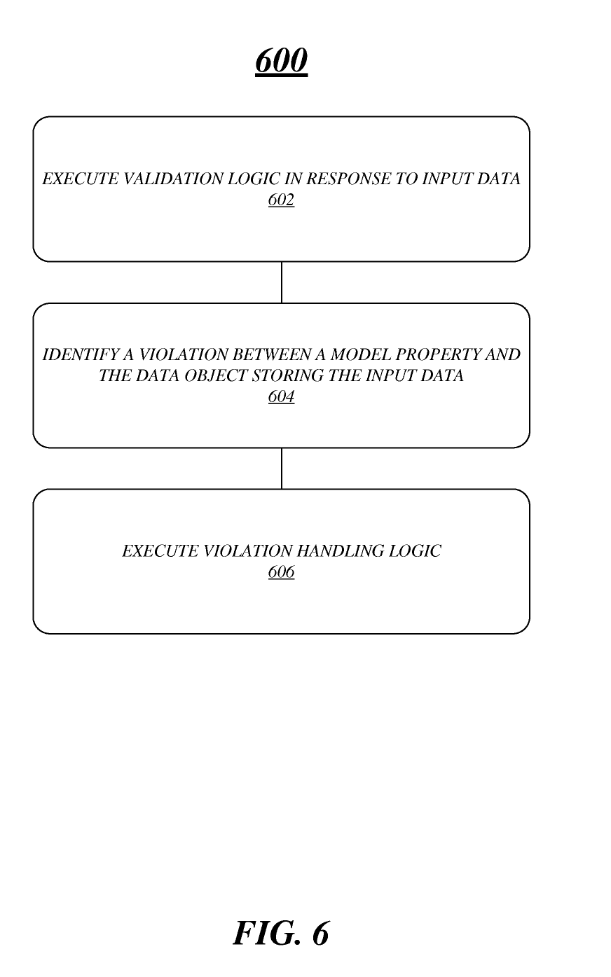

FIG. 6 illustrates one embodiment of a logic flow 600. The logic flow 600 may be representative of some or all of the operations executed by one or more embodiments described herein.

In the illustrated embodiment shown in FIG. 6, the logic flow 600 executes validation logic in response to input data at block 602. For example, a user interface component executes the validation logic to perform object validation on any data object storing the input data. The logic flow 600 identifies a violation event between a model property and the data object storing the input data at block 604. The logic flow 600 may execute violation handling logic to handle the violation event at block 606. If the input data is of an unexpected file format or data type, for instance, the user interface component executes the violation handling logic to mitigate any errors related to the violation events, present user interface elements in a mechanism to correct the input data, and/or terminate any running application. The user interface component may display a violation notification to alert a user and have the violation notification redirect a computer focus to a user interface element corresponding to the violating input data. The embodiments are not limited to this example.

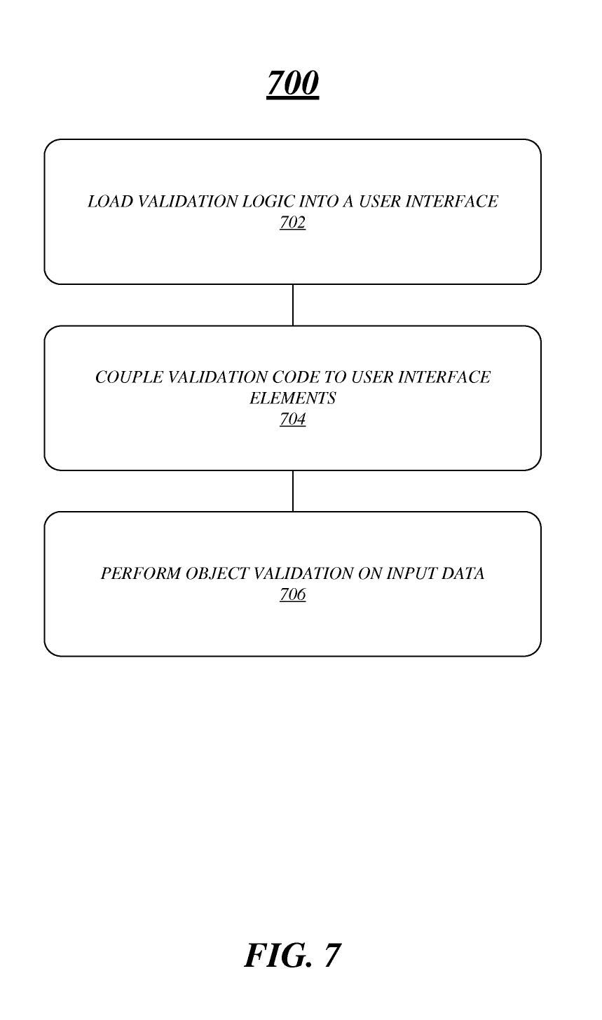

FIG. 7 illustrates one embodiment of a logic flow 700. The logic flow 700 may be representative of some or all of the operations executed by one or more embodiments described herein.

In the illustrated embodiment shown in FIG. 7, the logic flow 700 loads validation logic into a user interface at block 702. In one embodiment, a server communicates computer code and other data to an application running on a client device. This may be accomplished via a code sharing mechanism (e.g., Google® Web Toolkit™ (GWT) shared class technology) through which a server application running on the server and the client application implement a same or similar set of classes. The server application may designate certain classes as shared classes while other classes comprise server-side logic. In one embodiment, the shared classes may be shared as executable object code (e.g., bytecode) or human-readable source code.

It is appreciated that while the code sharing mechanism may be implemented using a particular programming language, the shared classes may be implemented in a different programming language or in an application development platform that does not support the particular programming language. It is also appreciated that while the code sharing mechanism and the shared classes may be implemented using a same programming language, the shared classes, once instantiated, may be operative to perform object validation on data objects that are generated in accordance with a different programming language (e.g., a non-GWT Specification). The client application, for instance, may run in JavaScript while the sharing mechanism runs in Java. Hence, the shared classes operate as custom object validation logic for the client application such that each data object corresponding to specific validation code.

The logic flow 700 couples appropriate validation code portions to user interface elements at block 704. It is appreciated that the in other embodiments, the custom object validation logic does not need to be partitioned into the validation code portions and may remain as one logic unit. The client application may include a user interface component that configures each coupled user interface element to process user inputs and execute the appropriate validation code portion on any input data. The logic flow 700 perform object validation on the input data at block 706. The embodiments are not limited to this example.

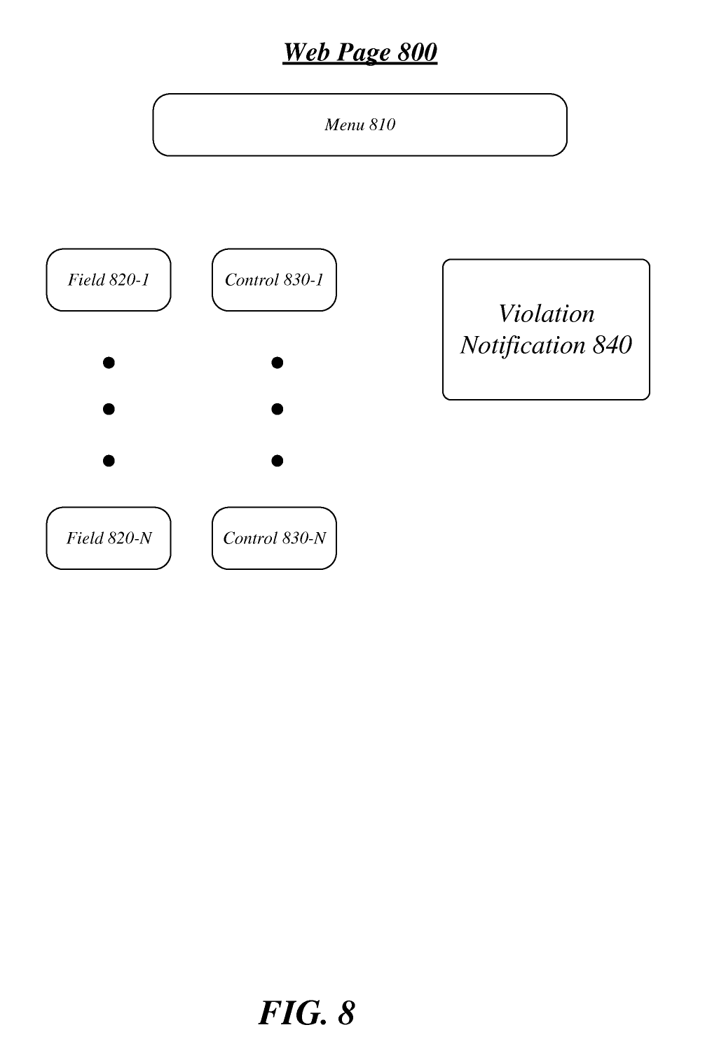

FIG. 8 illustrates an embodiment of a web page 800 to present a user interface. Any display device may be used to render the web page 800 and express the user interface on the web page 800. In an embodiment, the web page 800 includes a number of user interface elements, including a menu 810, a plurality of fields 820-1 . . . N, and a plurality of controls 830-1 . . . N. The user interface elements process input data in a variety of forms. One or more user interface elements may be configured to process input data via a particular input mode. As an example, the menu 810 may include a drop-down dialog box illustrating a number of possible (menu) choices. The menu 810 provides the drop-down dialog box to receive user selection(s) as a click-button action. The control 830-1 may include a radio button as an input mode. Activating the radio button initiates an event for the user interface component to handle.

As yet another example, the field 820 refers to a form field of an electronic document. An application running in the computing device may configure the user interface to express the electronic document as an online form using the user interface elements. User inputs, including entering data into the fields 820-1 . . . N as text or files and manipulating the controls 830-1 and the menu 810, may complete the online form for submission to a server. The application may generate data objects to store various data items related to the online form, such as user entered text, uploaded files, menu selections, events and control directives and/or the like. These data items may be expected to comply with a model implemented at the server that defines model properties for databases which the server maintains to store the electronic documents. When a user's input causes a violation event with respect to the model, such a model violation may be isolated to a particular data object and furthermore, to a particular data item's form field.

The application includes a user interface component that advantageously is operative to identify the user interface element and the corresponding data item causing the model violation. To illustrate by way of an example, if the application includes code configured to process input data in the form of integers but receives character strings instead, the user interface component identifies the data object and a specific data item storing the input data as the model violation's source. The user interface component, executing validation logic, determine whether that data item's model property does not comply with the model or whether the input data contains errors. In case of user error, the user interface component generates a violation notification 840 on the web page 800 to alert the user of incorrectly entered data. The violation notification 840 may indicate to which user interface element the user incorrectly entered data.

If the data item is not in compliance with the model's prescribed model property for that data item, code for the application may contain errors. Accordingly, the user interface component enhances unit testing of the application by identifying such errors. In an embodiment, the user interface component generates the violation notification 840 to alert the user (e.g., the unit tester). Alternatively, the user interface component generates mappings associating model violation events to specific data items and corresponding form fields, such as the field 820-1.

To illustrate enhanced unit testing by way of example, consider an example enterprise application operative to manage storage volumes for a networked computing environment. The web page 800 may function as an interface through which the unit tester controls the example enterprise application. If the field 820-1 is configured to accept as input data a storage volume size, in bytes, for a new storage volume to be created, the user interface component invokes validation logic to determine whether the input data complies with the model's storage volume size constraints. If the input data violates any of these constraints, for example, by exceeding a maximum storage volume size, the validation logic communicates a model violation event identifying the maximum storage volume size constraint and the user interface component identifies the field corresponding to a model violation source. The user interface component may determine that the field 820-1 is configured to provide the storage volume size data item for the model and thus, is likely to be the proximate cause of the model violation event. The user interface component may store a mapping in a separate data object (e.g., a validation object) to associate the storage volume size constraint to the corresponding form field(s) on the web page 800 and generate the violation notification 840. It is appreciated that the user interface component may implement any number of alternative notification modes for the model violation event. For example, the user interface component may highlight the border of the field 820-1 with a particular color.

Furthermore, the violating input data may cause a violation in another field according to one embodiment. If the storage volume size for the field 820-1 is used to populate data for the field 820-N, then that field may also violate the model. Consider an example where the field 820-N is used for inputting a number of storage volume owners, which is automatically generated based upon the storage volume size. Hence, if the storage volume size is in violation, the number automatically generated for the field 820-N would also be in violation. It is appreciated that the user interface component may implement generate multiple violation notifications to identify each violating field. The user interface component may disable the control 820-1 until a compliant storage volume size is entered into the field 820-1.

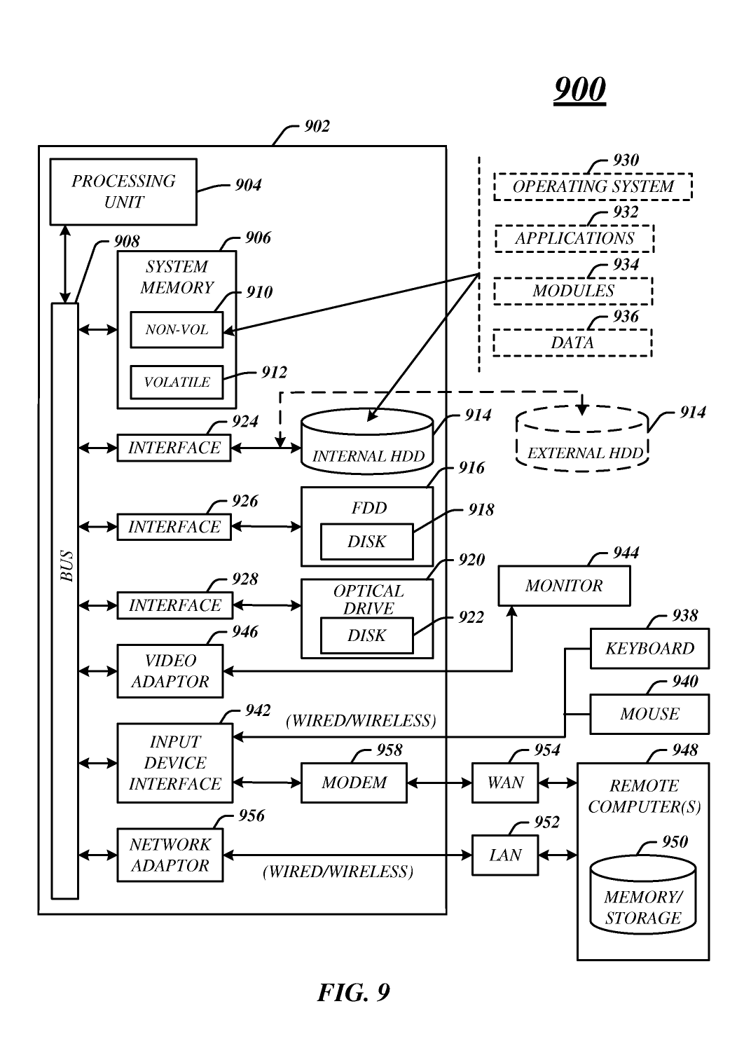

FIG. 9 illustrates an embodiment of an exemplary computing architecture 900 suitable for implementing various embodiments as previously described. In one embodiment, the computing architecture 900 may comprise or be implemented as part of an electronic device. Examples of an electronic device may include those described with reference to FIG. 2, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 990 is illustrated. The logical connections depicted include wire/wireless connectivity to a local area network (LAN) 992 and/or larger networks, for example, a wide area network (WAN) 994. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 992 through a wire and/or wireless communication network interface or adaptor 996. The adaptor 996 can facilitate wire and/or wireless communications to the LAN 992, which may also include a wireless access point disposed thereon for communicating with the wireless functionality of the adaptor 996.

When used in a WAN networking environment, the computer 902 can include a modem 998, or is connected to a communications server on the WAN 994, or has other means for establishing communications over the WAN 994, such as by way of the Internet. The modem 998, which can be internal or external and a wire and/or wireless device, connects to the system bus 908 via the input device interface 942. In a networked environment, program modules depicted relative to the computer 902, or portions thereof, can be stored in the remote memory/storage device 990. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.9 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

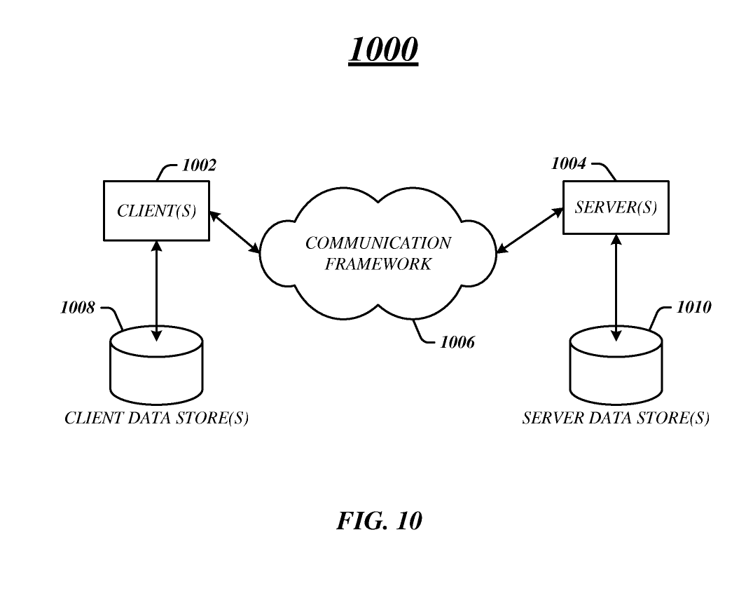

FIG. 10 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000.

As shown in FIG. 10, the communications architecture 1000 comprises includes one or more clients 1002 and servers 1004. The clients 1002 may implement the client device 210. The servers 1004 may implement the server device 230. The clients 1002 and the servers 1004 are operatively connected to one or more respective client data stores 1008 and server data stores 1010 that can be employed to store information local to the respective clients 1002 and servers 1004, such as cookies and/or associated contextual information.

The clients 1002 and the servers 1004 may communicate information between each other using a communication framework 10010. The communications framework 10010 may implement any well-known communications techniques and protocols. The communications framework 10010 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 10010 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.110 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1002 and the servers 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic circuit; and
a user interface component operative on the logic circuit to process a set of violation events corresponding to a user interface of an application, the user interface comprising user interface elements configured to process input data for the application, and store data to map each violation to a corresponding user interface element.

2. The apparatus of claim 1, wherein the user interface component further operative to identify a model violation and store data mapping the model violation to the corresponding user interface element.

3. The apparatus of claim 1, wherein the user interface component further operative to perform object validation on a data object storing the input data.

4. The apparatus of claim 3, wherein the data object is generated based upon the model.

5. The apparatus of claim 1, wherein the user interface component further operative to process validation logic communicated by a server.

6. The apparatus of claim 1, wherein the user interface component further operative to handle the set of violation events.

7. The apparatus of claim 1, wherein the user interface component further operative to store data mapping the corresponding user interface element to a property of a data object.

8. The apparatus of claim 1, wherein the user interface component further operative to store data in a data object indicating a model violation of the input data.

9. The apparatus of claim 1, wherein the user interface component further operative to display information identifying the corresponding user interface element associated with each violation of the set of violation events.

10. A computer-implemented method, comprising:
processing a user interface comprising user interface elements of which each element corresponds to a model property;
storing input data directed to at least one user interface element; and
executing validation logic on the input data, the validation logic configured to identify a violation between the input data and a model property of the at least one user interface element.

11. The method of claim 10, further comprising in response to identifying the violation, executing violation handling logic to process the violation.

12. The method of claim 10, further comprising generating a mapping between the at least one user interface element and the input data.

13. The method of claim 10, further comprising storing data associated with the violation in an object.

14. The method of claim 10, further generating a violation notification for presentation on the user interface.

15. The method of claim 10, further comprising executing the validation logic on a data object comprising the input data.

16. The method of claim 10, further comprising coupling a portion of the validation logic to a corresponding user interface element.

17. An article of manufacture having at least one computer-readable storage medium comprising instructions that when executed by a system, cause the system to:
process validation logic communicated by a server comprising a model;
load the validation logic to perform object validation on input data corresponding to a user interface; and
execute violation handling logic for at least one violation of the model by the input data.

18. The article of claim 17 further comprising instructions that when executed by the system, cause the system to: execute the validation logic on a data object generated by a client application in a different programming language.

19. The article of claim 17 further comprising instructions that when executed by the system, cause the system to: couple validation code portions to user interface elements.

20. The article of claim 17, wherein the violation handling logic is communicated by the server.
